(19) United States
(12) Patent Application Publication
(10) Pub. No.: US 2014/0037859 A1
(43) Pub. Date: Feb. 6, 2014

(54) PATTERN FORMATION METHOD AND DISPENSER

(71) Applicant: KABUSHIKI KAISHA TOSHIBA, Tokyo (JP)

(72) Inventor: Ayumi KOBIKI, Kanagawa-ken (JP)

(73) Assignee: KABUSHIKI KAISHA TOSHIBA, Tokyo (JP)

(21) Appl. No.: 13/776,865

(22) Filed: Feb. 26, 2013

(30) Foreign Application Priority Data
Aug. 3, 2012 (JP) 2012-172606

(51) Int. Cl. B05D 5/02

(52) U.S. Cl. CPC B05D 5/02
USPC 427/532; 427/372.2; 118/56

(57) ABSTRACT

According to one embodiment, a pattern formation method includes grouping an unevenness pattern of a template into a plurality of groups having different pattern sizes. The method includes using a nozzle having a relatively small nozzle diameter to dispense an imprint resist in liquid form into a region on a substrate where the unevenness pattern of a group of the plurality of groups having a relatively small pattern size is to be aligned, and using a nozzle having a relatively large nozzle diameter to dispense the liquid imprint resist into one other region on the substrate where the unevenness pattern of a group of the plurality of groups having a relatively large pattern size is to be aligned. The method includes curing the imprint resist. The method includes releasing the template from the cured imprint resist.

### CROSS-REFERENCE TO RELATED APPLICATION

This application is based upon and claims the benefit of priority from Japanese Patent Application No. 2012-172606, filed on Aug. 3, 2012; the entire contents of which are incorporated herein by reference.

### FIELD

Embodiments described herein relate generally to a pattern formation method and a dispenser.

### BACKGROUND

Pattern transfer technology by imprinting is drawing attention as technology to realize both the formation and suitability for mass production of a fine pattern in the manufacturing processes of a semiconductor element. In imprinting, an imprint resist which is a liquid organic material, etc., is supplied onto a substrate and cured by, for example, light irradiation in the state in which a template, in which an unevenness pattern is formed, is in contact with the imprint resist. An inkjet method has been proposed as a supply method of the imprint resist to dispense the imprint resist onto the substrate from, for example, multiple nozzles.

To eliminate pattern defects, it is necessary to improve the fillability of the imprint resist into the recesses of the template. To this end, the holding time from when the template is brought into contact with the imprint resist to when the light irradiation is performed may be increased; but the throughput decreases when the holding time is longer than necessary.

### BRIEF DESCRIPTION OF THE DRAWINGS

FIG. 1 is a schematic view of an imprint apparatus of an embodiment;

FIGS. 2A and 2B are schematic plan views of a nozzle of the imprint apparatus of the embodiment;

FIGS. 3A and 3B are schematic plan views of a nozzle of the imprint apparatus of the embodiment;

FIG. 4 is a flowchart showing a pattern formation method of the embodiment;

FIGS. 5A and 5B are schematic plan views showing a discharge of an imprint resist in the pattern formation method of the embodiment;

FIGS. 6A and 6B are schematic views of one droplet of the imprint resist dispensed from a first nozzle in the pattern formation of the embodiment;

FIGS. 7A and 7B are schematic views of one droplet of the imprint resist dispensed from a second nozzle in the pattern formation of the embodiment;

FIG. 8A to FIG. 9E are schematic cross-sectional views showing the pattern formation method of the embodiment;

FIG. 10A to FIG. 10F are schematic views comparing a spread rate of the imprint resist by differences of size of an unevenness pattern of a template;

FIG. 11 is a graph showing simulation results of a fill time depending on pattern sizes.

### DETAILED DESCRIPTION

According to one embodiment, a pattern formation method includes grouping an unevenness pattern of a template into a plurality of groups having different pattern sizes. The method includes using a nozzle having a relatively small nozzle diameter to dispense an imprint resist in liquid form into a region on a substrate where the unevenness pattern of a group of the plurality of groups having a relatively small pattern size is to be aligned, and using a nozzle having a relatively large nozzle diameter to dispense the liquid imprint resist into one other region on the substrate where the unevenness pattern of a group of the plurality of groups having a relatively large pattern size is to be aligned. The method includes curing the imprint resist in a state in which the unevenness pattern of the template is caused to contact the imprint resist. The method includes releasing the template from the cured imprint resist.

Embodiments will now be described with reference to the drawings. Similar components in the drawings are marked with like reference numerals.

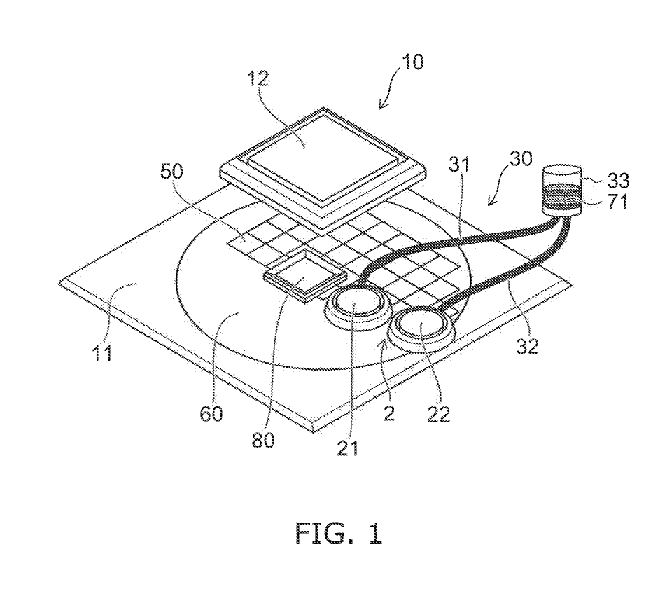

FIG. 1 is a schematic view of an imprint apparatus 10 of the embodiment.

The imprint apparatus 10 of the embodiment includes a wafer stage 11, a light source 12, and an inkjet apparatus 30.

A wafer 60 is held on the wafer stage 11. The wafer 60 includes a substrate and a patterning film to be patterned that is formed on the substrate. Or, the substrate itself may be a patterning material. The light source 12 is provided above the wafer stage 11 and emits, for example, ultraviolet light. A template 80 is moved relative to the wafer 60 in the space between the wafer 60 and the light source 12.

The inkjet apparatus 30 includes a dispenser 2 and a tank 33 in which an imprint resist 71 which is a liquid is stored. The dispenser 2 includes multiple (in FIG. 1, for example, two) heads 21 and 22. The heads 21 and 22 are movable in the horizontal direction and the vertical direction relative to the wafer stage 11. Multiple nozzles that dispense the imprint resist 71 are formed in the head 21 and in the head 22.

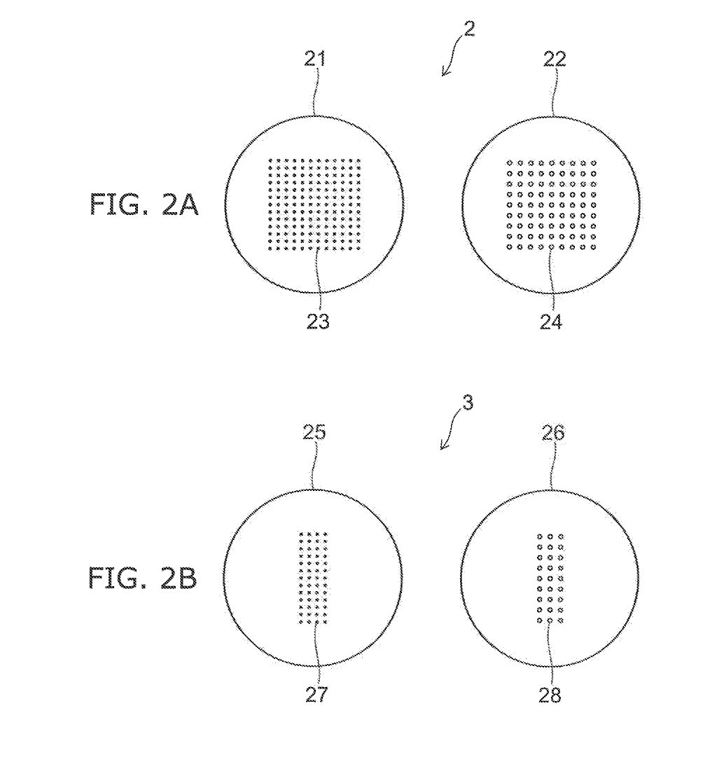

FIG. 2A is a schematic plan view of the surface of the head 21 and the surface of the head 22 (in FIG. 1, the surfaces on the lower side) that face the wafer 60.

According to the embodiment, as described below, nozzles having different nozzle diameters are used according to the different sizes of the unevenness pattern of the template 80.

Multiple first nozzles 23 are made in one head 21 of the dispenser 2 shown in FIG. 2A. The first nozzles 23 are connected to the tank 33 the tank via a pipe 31 shown in FIG. 1. Each of the multiple first nozzles 23 has the same first nozzle diameter. The first nozzle diameter is the hole diameter of the portion of the first nozzle 23 corresponding to the dispensing aperture on the most downstream side.

Multiple second nozzles 24 are made in the other head 22. The second nozzles 24 are connected to the tank 33 via a pipe 32 shown in FIG. 1. Each of the multiple second nozzles 24 has the same second nozzle diameter. The second nozzle diameter is the hole diameter of the portion of the second nozzle 24 corresponding to the dispensing aperture on the most downstream side. The second nozzle diameter is larger than the first nozzle diameter of the first nozzles 23.

The multiple first nozzles 23 and the multiple second nozzles 24 are made in regions having, for example, square configurations that have the same surface area. The number of the multiple second nozzles 24 that are made in the head 22 and have the nozzle diameter that is larger than that of the first nozzles 23 is less than the number of the multiple first nozzles 23 that are made in the head 21.

As shown in FIG. 1, the size (the planar size) of the template 80 is less than the surface area (the surface area of the pattern formation surface) of the wafer 60. The pattern formation surface of the wafer 60 is divided into multiple shot regions 50. In FIG. 1, the shot regions 50 for which the patterns are already transferred by the imprinting are schematically illustrated by the rectangular regions.

The steps of supplying the imprint resist 71, causing the template 80 to contact the imprint resist 71, curing the imprint resist 71, and releasing the template 80 from the cured imprint resist 71 are performed for one of the shot regions 50 and are multiply repeated for the number of the shot regions 50.

The heads 21 and 22 shown in FIG. 2A are heads for collective shots in which the imprint resist 71 is collectively dispensed and distributed over one entire shot region 50.

Scanning may be used as the supply method of the imprint resist 71 into one shot region 50.

FIG. 28 shows a dispenser 3 used in the scanning. The dispenser 3 includes two heads 25 and 26. FIG. 2B is a schematic plan view of the surface of the head 25 and the surface of the head 26 that face the wafer 60.

Multiple first nozzles 27 are made in the head 25 which is one of the heads of the dispenser 3. Similarly to the dispenser 2 described above, the first nozzles 27 are connected to the tank 33 shown in FIG. 1 via the pipe. Each of the multiple first nozzles 27 has the same first nozzle diameter. The first nozzle diameter is the hole diameter of the portion of the first nozzle 27 corresponding to the dispensing aperture on the most downstream side.

Multiple second nozzles 28 are made in the other head 26. The second nozzles 28 also are connected to the tank 33 via the pipe. Each of the multiple second nozzles 28 has the same second nozzle diameter. The second nozzle diameter is the hole diameter of the portion of the second nozzle 28 corresponding to the dispensing aperture on the most downstream side. The second nozzle diameter of the second nozzles 28 is larger than the first nozzle diameter of the first nozzles 27.

The multiple first nozzles 27 and the multiple second nozzles 28 are made in, for example, rectangular regions having the same surface area. The number of the multiple second nozzles 28 made in the head 26 is less than the number of the multiple first nozzles 27 made in the head 25.

The head 25 moves relative to the wafer 60 in a direction (in FIG. 2B, the lateral direction) orthogonal to the longitudinal direction of the rectangular region where the first nozzles 27 are made. Similarly, the head 26 moves relative to the wafer 60 in a direction (in FIG. 2B, the lateral direction) orthogonal to the longitudinal direction of the rectangular region where the second nozzles 28 are made. By this movement, the imprint resist 71 can be dispensed and distributed over one entire shot region 50.

The first nozzles and the second nozzles that have relatively different nozzle diameters may be provided in the same head. Costs can be reduced by reducing the number of heads.

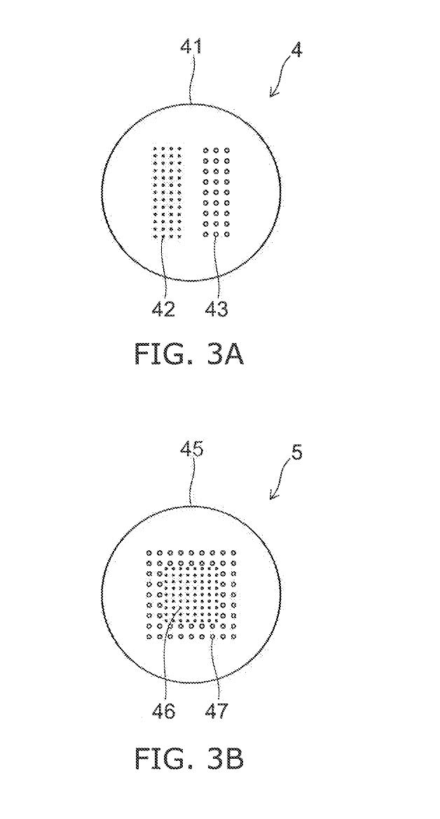

FIG. 3A and FIG. 3B show dispensers 4 and 5. The dispenser 4 includes one head 41. The dispenser 5 includes one head 45. FIG. 3A and FIG. 3B are schematic plan views of the surface of the head 41 and the surface of the head 45 that face the wafer 60.

The dispenser 4 shown in FIG. 3A has a structure in which multiple first nozzles 42 having the first nozzle diameter and multiple second nozzles 43 having the second nozzle diameter which is larger than the first nozzle diameter are made in the same head 41.

The multiple first nozzles 42 correspond to the multiple first nozzles 27 shown in FIG. 2B; the multiple second nozzles 43 correspond to the multiple second nozzles 28 shown in FIG. 2B; and the multiple first nozzles 42 and the multiple second nozzles 43 are arranged in rectangular regions for scanning.

The dispenser 5 shown in FIG. 3B has a structure in which multiple first nozzles 46 having the first nozzle diameter and multiple second nozzles 47 having the second nozzle diameter which is larger than the first nozzle diameter are made in the same head 45.

The head 45 is a head for a collective shot in which the imprint resist 71 is collectively dispensed and distributed over one entire shot region 50. The second nozzles 47 are provided further toward the outer side of the surface of the head 45 that faces the wafer 60 than are the first nozzles 46. The first nozzles 46 are made, for example, in a region having a square configuration; and the second nozzles 47 are made around the region of the first nozzles 46.

In many cases, a fine pattern having a relatively small pattern size is on the inner side of the shot region 50; and a pattern having a relatively large size is on the outer circumferential side of the shot region 50. Therefore, in the head 45 shown in FIG. 3B, the first nozzles 46 having the small nozzle diameter used for the fine pattern are made in the region that faces the inner side of the shot region 50; and the second nozzles 47 having the nozzle diameter that is larger than that of the first nozzles 46 are made in the region that faces the outer circumferential side of the shot region 50.

Pressurizing chambers connected to the multiple nozzles 23, 24, 27, 28, 42, 43, 46, and 47 and piezoelectric elements that vary the pressure inside the pressurizing chambers by deforming the wall portions of the pressurizing chambers are provided in the heads 21, 22, 25, 26, 41, and 45 described above. By the pressure variation inside the pressurizing chambers, the imprint resist 71 is suctioned from the tank 33 into the pressurizing chambers and forced toward the nozzles 23, 24, 27, 28, 42, 43, 46, and 47.

By the control of the individual piezoelectric elements, the dispense amount and whether or not to dispense the imprint resist 71 can be controlled for the multiple nozzles 23, 24, 27, 28, 42, 43, 46, and 47. This is not limited to driving the piezoelectric elements; and the imprint resist 71 may be dispensed from the nozzles 23, 24, 27, 28, 42, 43, 46, and 47 by a thermal method.

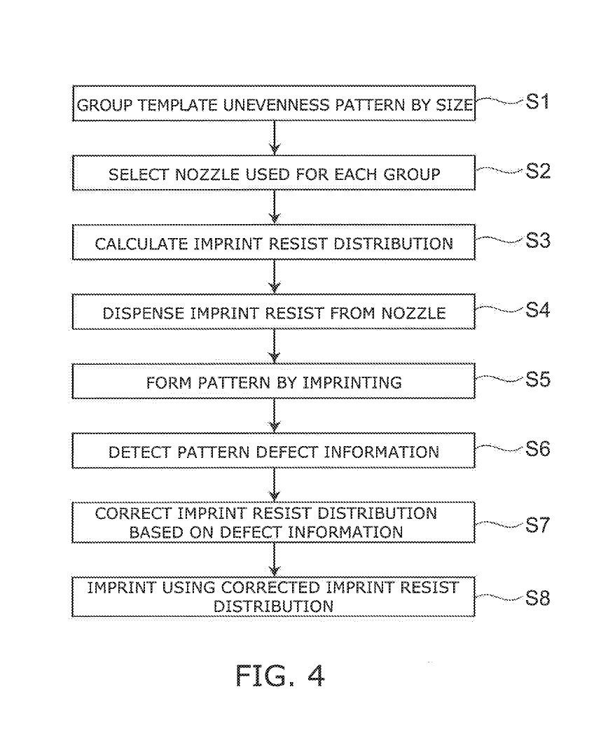

The pattern formation method of the embodiment will now be described with reference to the flowchart of FIG. 4.

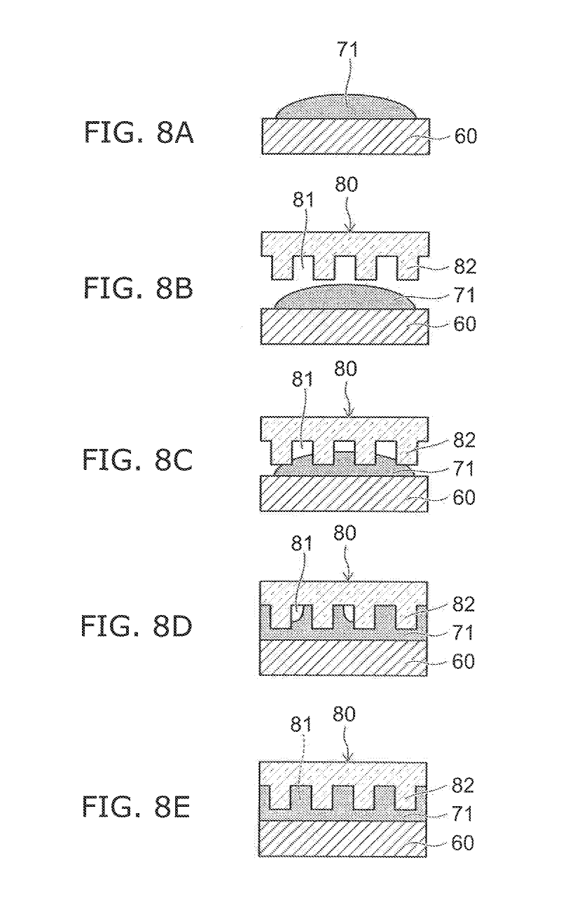

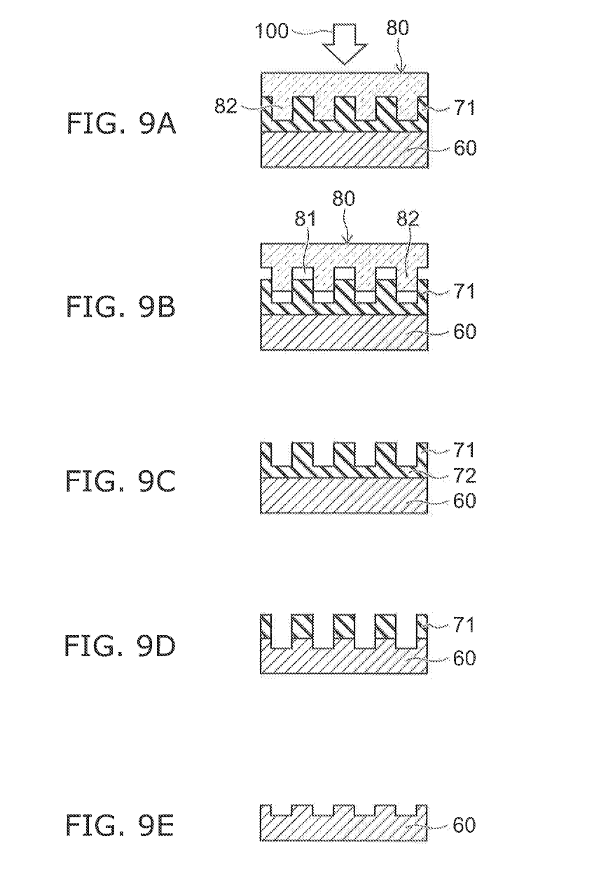

FIG. 8A to FIG. 9E are schematic cross-sectional views showing the processes after the imprint resist 71 is supplied onto the wafer 60. FIG. 8A to FIG. 9E are enlarged cross-sectional views of a region in the shot region 50 where the imprint resist 71 is dispensed from one nozzle.

As shown in FIG. 8B, an unevenness pattern in which multiple recesses 81 and multiple protrusions 82 are repeated is formed in the template 80.

First, as step S1 in the flowchart of FIG. 4, the unevenness pattern formed in one template 80 is grouped into multiple groups having different pattern sizes. Here, the pattern size is the surface area of the bottoms of the recesses 81, the spacing between the protrusions 82 that are adjacent to each other with the recess 81 interposed, the depth of the recesses 81, or the height of the protrusions 82.

According to the embodiment, the unevenness pattern of the template 80 is divided into two, e.g., a first group and a second group. The first group is a group of a fine unevenness pattern for which the pattern size is smaller than, for example, 1 μm; and the second group is a group of a large-sized unevenness pattern (e.g., a pattern size not less than 1 μm) for which the pattern size is larger than that of the first group.

Then, as step S2, the nozzles used to imprint the unevenness patterns of the groups are selected.

In the embodiment, one selected from the first nozzles 23, 27, 42, and 46 described above which have the first nozzle diameter (these are typified by the first nozzles 23 in the description recited below, but the same effects also are obtained for the other first nozzles 27, 42, and 46) are used in the imprinting of the unevenness pattern of the first group.

One selected from the second nozzles 24, 28, 43, and 47 which have the second nozzle diameter which is larger than the first nozzle diameter (these are typified by the second nozzles 24 in the description recited below, but the same effects also are obtained for the other second nozzles 28, 43, and 47) are used in the imprinting of the unevenness pattern of the second group.

Then, as step S3, the imprint resist distribution on the pattern formation surface of the wafer 60 where the unevenness pattern of each of the groups is to be aligned is calculated.

The imprint resist distribution is calculated by considering the size of the unevenness pattern, the density (the density unevenness) of the unevenness pattern, the evaporation amount of the imprint resist 71 after the dispensing, the thickness of a remaining film layer 72 (shown in FIG. 9C) of the imprint resist 71 called the RLT (residual layer thickness), etc.

Information of the nozzles that are used, the position of each of the nozzles inside the shot region, and the dispense amount of the imprint resist 71 from each of the nozzles are included in the data of the imprint resist distribution and are set such that the appropriate amount of the imprint resist 71 is dispensed from the nozzles at the appropriate positions.

As step S4, the liquid imprint resist is dispensed into the shot region 50 from the nozzles based on the imprint resist distribution data.

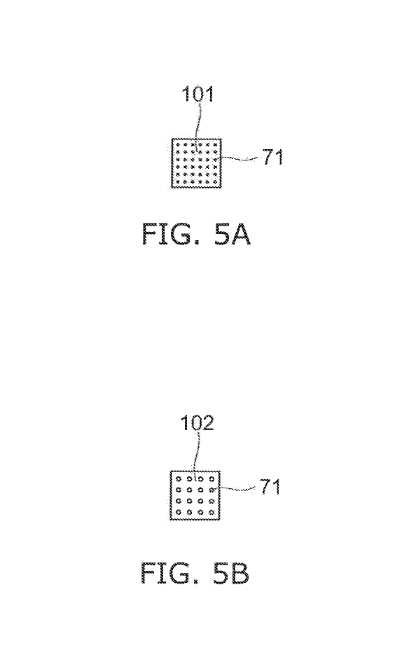

FIG. 5A shows a first region 101 where the unevenness pattern of the first group having the small pattern size is to be aligned in the shot region 50.

In the first region 101, the liquid imprint resist 71 is dispensed using the multiple first nozzles 23 having the first nozzle diameter.

In the transfer region of the fine unevenness pattern, the first nozzles 23 which have the nozzle diameter that is smaller than that of the second nozzles 24 are used because the RLT (residual layer thickness) can be controlled more easily when the liquid droplets of the imprint resist 71 are caused to be fine.

FIG. 5B shows a second region 102 (a region separate from the first region 101) where the unevenness pattern of the second group having the pattern size that is larger than that of the first group is to be aligned in the shot region 50.

In the second region 102, the liquid imprint resist 71 is dispensed using the second nozzles 24 having the second nozzle diameter which is larger than the first nozzle diameter.

The distribution of the imprint resist, which is multiple droplets dropped from the first nozzles 23 and the second nozzles 24, is not limited to uniform distributions having uniform spacing as shown in FIGS. 5A and 5B. There are cases where there is a density unevenness in the liquid droplet distribution due to the density of the unevenness pattern of the template 80 or to compensate for the evaporation of the imprint resist 71 after the dropping; and the sizes of the liquid droplets may differ. In other words, based on the data of the imprint resist distribution obtained in step S3, the dispense amount and whether or not to dispense the imprint resist 71 is controlled for each nozzle.

Then, as step S5, the imprinting and the pattern formation are performed using the template 80.

FIG. 8A is an enlarged cross section of a region where the liquid imprint resist 71 is dispensed from any one nozzle of the multiple first nozzles 23 or the multiple second nozzles 24.

As shown in FIGS. 8B to 8D, the unevenness pattern of the template 80 is caused to contact the imprint resist 71. Then, the template 80 is held in the state of being in contact with the imprint resist 71 at the prescribed position shown in FIG. 8D; and the imprint resist 71 is filled completely into the recesses 81 of the template 80 as shown in FIG. 8E.

The time for the imprint resist 71 to be filled into the recesses 81 of the unevenness pattern of the template 80 depends on the pattern size. The period of time for the imprint resist 71 to be filled into the recesses 81 decreases as the pattern size decreases. Accordingly, the holding time to fill the imprint resist 71 into the recesses 81 is shorter for finer patterns. Patterns having relatively large sizes such as dummy patterns and alignment marks that function as actual circuit components require a holding time that is longer than that of a fine pattern.

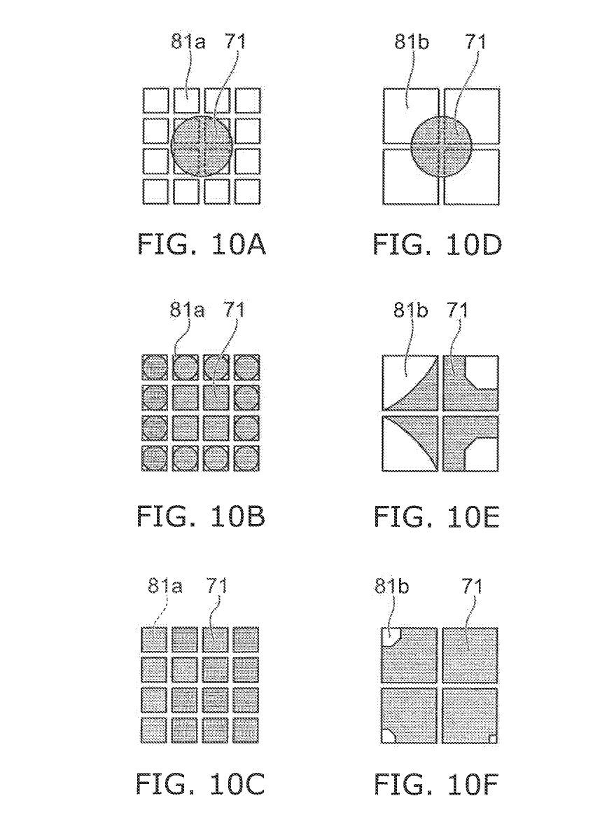

FIGS. 10A to 10F are schematic views comparing the fill time (rate) of the imprint resist 71 for the same drop amount between recesses 81a of the unevenness pattern of the template 80 having a small pattern size (planar size) and recesses 81b of the unevenness pattern of the template 80 having a pattern size that is larger than that of the recesses 81a. In FIGS. 10A to 10F, the imprint resist 71 is illustrated by a dot-like cross hatching pattern.

FIGS. 10A to 10F are schematic plan views as viewed from the side of the surface of the template 80 where the unevenness pattern is formed. FIGS. 10A to 10C show a region where sixteen recesses 81a are arranged four lengthwise and four crosswise; and FIGS. 10D to 10F show a region having the same surface area as that of FIGS. 10A to 10C where four recesses 81b are arranged two lengthwise and two crosswise.

FIGS. 10A to 10C show the filling of the imprint resist 71 into the recesses 81a which have the small pattern size. FIGS. 10D to 10F show the filling of the imprint resist 71 into the recesses 81b which have the pattern size that is larger than that of the recesses 81a.

The time axis is the same in FIG. 10A and FIG. 10D; and a point in time when the unevenness pattern of the template 80 is caused to contact the imprint resist 71 is shown.

The time axis is the same in FIG. 10B and FIG. 10E; and a point in time 20 seconds after the point in time of FIG. 10A and FIG. 10D is shown.

The time axis is the same in FIG. 10C and FIG. 10F; and a point in time 60 seconds after FIG. 10A and FIG. 10D is shown.

Although the imprint resist 71 is completely filled into the recesses 81a which have the small pattern size at the point in time after 60 seconds have elapsed as shown in FIG. 10C, unfilled locations of the imprint resist 71 still exist in the recesses 81b which have the large pattern size as shown in FIG. 10F at the same point in time after 60 seconds have elapsed. In other words, the holding time to cure while the template 80 is in contact with the imprint resist 71 is longer for the unevenness pattern of the large size than for the unevenness pattern of the small size.

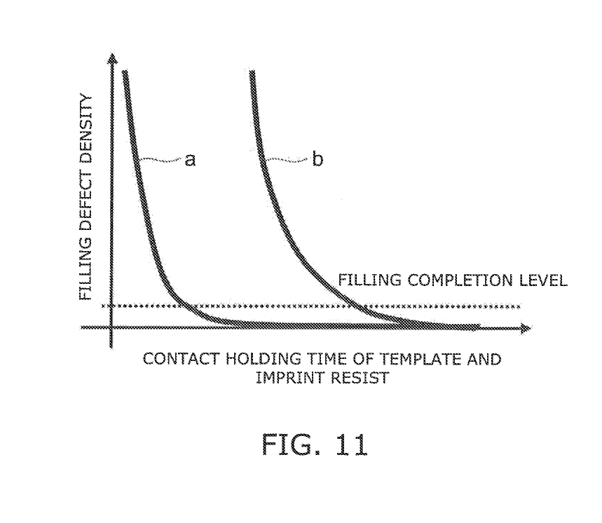

FIG. 11 is a graph showing the simulation results of the relationship between the holding time (the horizontal axis) and the filling defect density (the vertical axis) of the imprint resist 71 into the recesses 81 of the template 80 to compare a small pattern a having a small pattern size to a large pattern b having a pattern size that is larger than the pattern a.

As shown in FIG. 11, the small pattern a reaches the filling completion level illustrated by the broken line in a time that is shorter than that of the large pattern b. In the case where the imprinting is performed with priority placed on the throughput, for the large pattern b, there is a risk of pattern defects due to the imprint resist 71 being undesirably cured in the state in which the unfilled portions of the imprint resist 71 exist. In the case where the pattern size exceeds about 1 μm, the throughput easily decreases due to the increase of the holding time recited above, or the number of the pattern defects easily increases due to the filling defects of the imprint resist 71.

As described above, because the RLT (residual layer thickness) can be controlled more easily when the liquid droplet of the imprint resist 71 is caused to be fine in the transfer region of the fine unevenness pattern, there are many cases in the current state of the art where nozzles having a small nozzle diameter suited to a fine pattern are used in the imprinting. However, in the case where the nozzles having the small nozzle diameter are applied also to the transfer region of the large-size pattern, much time is necessary for the small liquid droplets to spread over all of the pattern recesses having the large size; and there is a risk that the throughput may decrease.

Therefore, according to the embodiment, the first nozzles 23 and the second nozzles 24 having the different nozzle diameters are prepared and are used according to the pattern size of the unevenness pattern of the template 80.

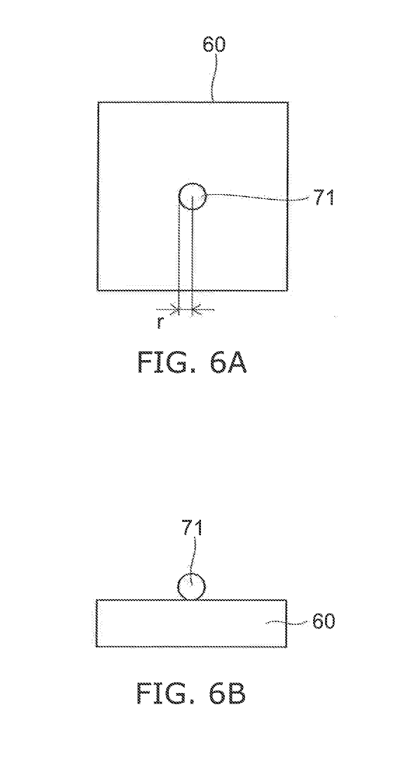

FIG. 6A is a schematic top view of one droplet of the imprint resist 71 dispensed from the first nozzle 23 into the transfer region of the pattern of the first group recited above having the relatively small pattern size; and FIG. 6B is a side view of FIG. 6A.

In the case where the nozzle diameter is small, the effect of the surface tension is relatively greater than the effect of gravity; and the liquid droplet dispensed from the first nozzle 23 easily becomes spherical. The volume of one droplet is 4/3πr³, where r is the radius of the liquid droplet. Accordingly, the dispense amount of one droplet from the first nozzle 23 can be controlled by controlling one type of parameter, i.e., parameter r.

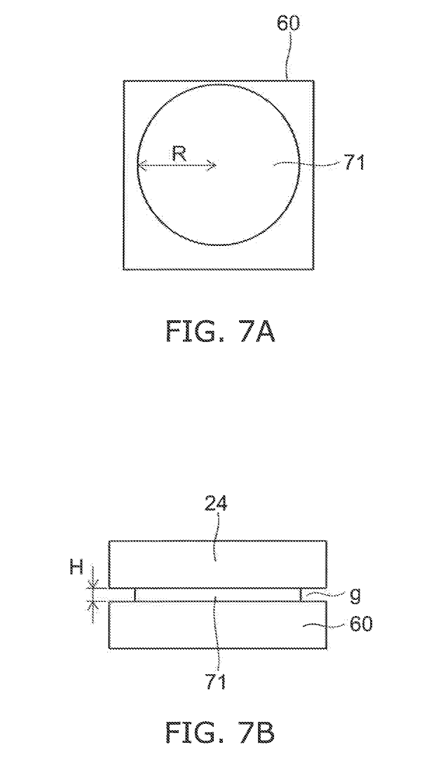

FIG. 7A is a schematic top view of one droplet of the imprint resist 71 dispensed from the second nozzle 24 into the transfer region of the pattern of the second group recited above having the relatively large pattern size; and FIG. 7B is a side view of FIG. 7A.

In the case where the nozzle diameter is large, it is possible to drop the imprint resist 71 onto the wafer 60 in the state of the imprint resist 71 being spread in a film-like configuration by dispensing the imprint resist 71 with the second nozzle 24 proximal to the wafer 60. The volume of one droplet is πR²H, where the radius of the liquid droplet is R, and the height of a gap g between the pattern formation surface of the wafer 60 and the second nozzle 24 is H.

Thus, the liquid droplet diameter during the dropping can be enlarged by dropping the imprint resist 71 into the pattern transfer region having the large size using the second nozzles 24 which have the large nozzle diameter. Thereby, the time for the imprint resist 71 to spread over the large-size pattern can be reduced; and the filling rate (the throughput) of the imprint resist 71 into the recesses 81 of the template 80 can be increased. Also, it is possible to reduce the number of pattern defects due to the imprint resist 71 being undesirably cured in the state in which the unfilled portions exist. Accordingly, according to the embodiment, a pattern transfer having high precision can be realized with high throughput.

The dispense amount of one droplet of the imprint resist 71 from the second nozzle 24 having the nozzle diameter that is larger than that of the first nozzle 23 can be greater than the dispense amount of one droplet from the first nozzle 23. Accordingly, the number of the second nozzles 24 and the number of dispenses of the second nozzles 24 can be less than those of the first nozzles 23 when dispensing the imprint resist 71 of the same amount over one entire shot region 50.

The imprint resist distribution data described above is generated by individually setting the dispense amount and/or the number of dispenses for the individual nozzles and assigning the settings to the positional information. Accordingly, the data amount (the data size) of the setting data including the dispense amount and/or the number of dispenses for each nozzle can be small for the second nozzles 24 which are fewer than the first nozzles 23.

Accordingly, compared to the case where the first nozzles 23 are applied to the large-size pattern, the time to generate the data of the imprint resist distribution can be shortened and the data transfer time from an external control apparatus, etc., into the imprint apparatus 10 can be shortened by applying the second nozzles 24 to the large-size pattern.

After the liquid imprint resist 71 is filled completely into the recesses 81 of the template 80 as shown in FIG. 8E described above, ultraviolet light 100 is irradiated onto the imprint resist 71 as shown in FIG. 9A. The imprint resist 71 is a photocurable organic material and is cured by irradiating the ultraviolet light 100.

The template 80 is made of, for example, quartz that is transmissive to the ultraviolet light 100. The ultraviolet light 100 is irradiated onto the imprint resist 71 from the template 80 side. The imprint resist 71 may be cured by utilizing light other than ultraviolet light. Or, the imprint resist 71 may be cured by heating using a thermosetting organic material as the imprint resist 71.

After curing the imprint resist 71, the template 80 is released from the imprint resist 71 as shown in FIGS. 9B to 9C.

As shown in FIG. 9C, the unevenness pattern which is the inverted unevenness pattern of the template 80 is transfer-formed onto the imprint resist 71.

Then, the patterning film of the wafer 60 is etched using the cured imprint resist 71, in which the unevenness pattern is formed, as a mask. Thereby, as shown in FIG. 9D, the unevenness pattern is formed in the patterning film of the wafer 60. Subsequently, the imprint resist 71 is removed from the wafer 60 as shown in FIG. 9E.

Then, as step S6 of the flowchart of FIG. 4, defect information of the pattern formed in the patterning film of the wafer 60 is detected.

For example, defects unique to the imprint process are detected by placing the wafer 60 in an optical defect inspection apparatus and implementing a pattern defect inspection using a Die-to-Die method or a Cell-Array method.

Although defects such as particles, dust, etc., caused by factors other than imprint process factors are detected in the defect inspection, here, the detection is performed with particular emphasis on mainly the unfilled defects of the imprint resist 71 that are characteristic of the imprint process.

There are many cases where the unfilled defects of the imprint resist 71 occur due to the imprint resist 71 being locally insufficient, the fill time (the contact holding time between the template 80 and the imprint resist 71) being insufficient, etc. There are cases where the unfilled defects of the imprint resist 71 occur not only inside one shot region 50 but also in a wide distribution in the wafer surface because patterning unevenness exists due to the foundation processes of the process wafer, etc.

In any case, classification can be performed by, for example, SEM (scanning electron microscope) review because there are many cases where the unfilled defects of the imprint resist 71 cause large-scale defects or large-size defects which can be easily classified. Or, a similar inspection is possible using a defect inspection apparatus using an EB (electron beam) method, etc.

Then, as step S7, the imprint resist distribution is corrected based on the defect information. Namely, the defect information detected in step S6 is provided as feedback to the imprint resist distribution calculated in step S3. Here, among the defects that are detected, there are many cases where the information of only the defects unique to the imprint process, particularly, the information of only the unfilled defects, is used. The information that is provided as feedback is, for example, the positional coordinates and the defect sizes of the defects. Based on the information, the imprint resist distribution is corrected by adjusting the dispense amount from each of the nozzles by calculating the imprint resist supply amount that is locally insufficient, etc.

Continuing, as step S8, imprinting similar to step S4 described above is performed based on the imprint resist distribution that is corrected.

Although the two types of the first nozzles 23, 27, 42, and 46 and the second nozzles 24, 28, 43, and 47 which have different nozzle diameters are used according to the pattern size of the template 80 in the embodiment described above, three or more types of nozzles having different nozzle diameters may be used according to the pattern size of the template 80.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A pattern formation method, comprising:
grouping an unevenness pattern of a template into a plurality of groups having different pattern sizes;
using a nozzle having a relatively small nozzle diameter to dispense an imprint resist in liquid form into a region on a substrate where the unevenness pattern of a group of the plurality of groups having a relatively small pattern size is to be aligned, and using a nozzle having a relatively large nozzle diameter to dispense the liquid imprint resist into one other region on the substrate where the unevenness pattern of a group of the plurality of groups having a relatively large pattern size is to be aligned;
curing the imprint resist in a state in which the unevenness pattern of the template is caused to contact the imprint resist; and
releasing the template from the cured imprint resist.

2. The method according to claim 1, wherein the imprint resist is cured by irradiating light onto the imprint resist.

3. The method according to claim 1, wherein the pattern size is a surface area of a bottom of a recess of the unevenness pattern of the template.

4. The method according to claim 1, wherein the pattern size is a spacing between protrusions of the unevenness pattern of the template adjacent to each other with a recess of the unevenness pattern interposed.

5. The method according to claim 1, wherein the pattern size is a depth of a recess of the unevenness pattern of the template or a height of a protrusion of the unevenness pattern of the template.

6. The method according to claim 1, wherein the imprint resist is dispensed from the nozzle based on imprint resist distribution data including at least one selected from a dispense amount of the imprint resist and a number of dispenses of the imprint resist for each of the nozzles.

7. A pattern formation method, comprising:
grouping an unevenness pattern of a template into a plurality of groups having different pattern sizes;
using a plurality of first nozzles having a first nozzle diameter to dispense an imprint resist in liquid form into a region on a substrate where the unevenness pattern of a group of the plurality of groups having a relatively small pattern size is to be aligned, and using a plurality of second nozzles having a second nozzle diameter to dispense the liquid imprint resist into one other region on the substrate where the unevenness pattern of a group of the plurality of groups having a relatively large pattern size is to be aligned, the second nozzle diameter being larger than the first nozzle diameter, the number of the plurality of second nozzles being less than the number of the first nozzles;
curing the imprint resist in a state in which the unevenness pattern of the template is caused to contact the imprint resist; and
releasing the template from the cured imprint resist.

8. The method according to claim 7, wherein the imprint resist is cured by irradiating light onto the imprint resist.

9. The method according to claim 7, wherein the pattern size is a surface area of a bottom of a recess of the unevenness pattern of the template.

10. The method according to claim 7, wherein the pattern size is a spacing between protrusions of the unevenness pattern of the template adjacent to each other with a recess of the unevenness pattern interposed.

11. The method according to claim 7, wherein the pattern size is a depth of a recess of the unevenness pattern of the template or a height of a protrusion of the unevenness pattern of the template.

12. The method according to claim 7, wherein the imprint resist is dispensed from the first nozzles and the second nozzles based on imprint resist distribution data including at least one selected from a dispense amount of the imprint resist and a number of dispenses of the imprint resist for the first nozzles and the second nozzles.

13. The method according to claim 12, wherein a data amount of the imprint resist distribution data of all of the plurality of second nozzles is smaller than a data amount of the imprint resist distribution data of all of the plurality of first nozzles.

14. A dispenser, comprising:
a plurality of first nozzles configured to dispense an imprint resist in liquid form onto a substrate, the plurality of first nozzles having a first nozzle diameter; and
a plurality of second nozzles configured to dispense the liquid imprint resist onto the substrate, the plurality of second nozzles having a second nozzle diameter larger than the first nozzle diameter.

15. The dispenser according to claim 14, wherein the number of the second nozzles is less than the number of the first nozzles.

16. The dispenser according to claim 14, wherein the first nozzles and the second nozzles are provided in the same head, the head being configured to move relative to the substrate.

17. The dispenser according to claim 16, wherein the number of the second nozzles is less than the number of the first nozzles.

18. The dispenser according to claim 16, wherein the second nozzles are provided further toward an outer side of a surface of the head than are the first nozzles, the surface of the head being configured to face the substrate.

19. The dispenser according to claim 18, wherein the number of the second nozzles is less than the number of the first nozzles.

20. The dispenser according to claim 14, wherein the first nozzle and the second nozzle are respectively provided in different heads configured to move relative to the substrate.
